(19) United States
(12) Patent Application Publication
(10) Pub. No.: US 2018/0360016 A1
(43) Pub. Date: Dec. 20, 2018

(54) LEVERAGE-ENHANCING SUPPORT FOR A FISHING POLE

(71) Applicant: Gary Denton, Chino, CA (US)

(72) Inventor: Gary Denton, Chino, CA (US)

(21) Appl. No.: 16/012,621

(22) Filed: Jun. 19, 2018

Related U.S. Application Data
(60) Provisional application No. 62/668,510, filed on May 8, 2018.
(60) Provisional application No. 62/522,566, filed on Jun. 20, 2017.

(51) Int. Cl. A01K 97/10

(52) U.S. Cl. CPC A01K 97/10

(57) ABSTRACT

A support for a fishing pole extends laterally from a longitudinal axis of the fishing pole when the fishing pole is oriented with the reel vertically above or below the fishing pole and a rotational axis of the reel oriented horizontally. The support has an armrest portion configured to contact the arm of a user holding the fishing pole at a spaced location from the fishing pole. In some configurations, the support comprises a frame and the armrest portion comprises a flexible portion having an unsupported portion extending between spaced-apart portions of the frame. In some configurations, the support provides improved access to a hand grip portion of the fishing pole located axially forward of the reel.

### BACKGROUND

### Field

The present disclosure relates to an armrest for a fishing pole, or other types of poles.

### Description of Related Art

A plurality of pistol grip-style handles for fishing poles or fishing poles incorporating a pistol grip-type arrangement exist. However, such arrangements provide limited usefulness to the user of the fishing pole.

### SUMMARY

A need exists for a more useful arrangement to assist a user of a fishing pole, or other pole, to resist rotation of the pole about its longitudinal axis or to lift the pole. One or more embodiments described herein assist a user of a fishing pole, or other pole, to resist rotation of the pole about its longitudinal axis, and/or to aid the user in lifting or holding the pole by partially supporting the fishing pole on the user's arm. Moreover, certain embodiments described herein enable a user greater flexibility and comfort in selecting a hand position along the length of the fishing pole. For example, certain embodiments provided enhanced access to a hand grip area of the fishing pole, as compared with prior solutions, while also providing partial support of the fishing pole on the user's arm.

The systems, methods and devices described herein have innovative aspects, no single one of which is indispensable or solely responsible for their desirable attributes. Without limiting the scope of the claims, some of the advantageous features will now be summarized.

In some configurations, a support for a fishing pole extends laterally from a longitudinal axis of the fishing pole when the fishing pole is oriented with the reel vertically above or below the fishing pole and a rotational axis of the reel is oriented horizontally. The support has an armrest portion configured to contact an upper portion of the arm of a user holding the fishing pole at a spaced location from the fishing pole.

In some configurations, the support for the fishing pole attaches at a location along the fishing pole axially forward of the reel.

In some configurations, the support comprises a frame and the armrest portion comprises a flexible portion having an unsupported portion extending between spaced-apart portions of the frame.

In some configurations, the flexible portion is only supported at its ends by the spaced-apart portions of the frame.

In some configurations, the flexible portion comprises a flexible material such as rubber, neoprene, natural or synthetic mesh material, or similar flexible materials.

In some configurations, the frame comprises a pair of arms, wherein each of the arms defines one of the spaced-apart portions of the frame.

In some configurations, the armrest portion is located beside or forward of the reel.

In some configurations, the support is coupled to the fishing pole at a location forward of the reel.

In some configurations, the support is adjustable in one or both of along the longitudinal axis of the fishing pole and around the longitudinal axis of the fishing pole.

In some configurations, the support is coupled with the fishing pole by a coupler. The coupler can maintain the position of the support (e.g., the angle of the support) with respect to the fishing pole.

In some configurations, the coupler is adjustable. The adjustable coupler can allow a user to adjust the position of the support with respect to the fishing pole.

In another configuration, an arm support for attaching to a fishing pole and improving access to a hand grip portion the fishing poles, includes a first member and a coupler. The first member can be coupled with the fishing pole at a location axially forward of a reel of the fishing pole. A second member can couple with the first member. The second member includes an armrest. The armrest contacts an upper portion of a forearm or wrist portion of a user's arm. The arm attaches to a hand that grips the fishing pole in the hand grip portion. A coupler attaches the first member with the fishing pole such that the arm support can maintain a position with respect to the fishing pole. The first member extends along the hand grip portion from the coupler towards the reel. The first member is radially offset above the second hand grip portion.

In some configurations, the armrest includes a frame and a flexible portion extending between spaced-apart portions of the frame, the flexible portion is supported at its ends by the spaced-apart portions of the frame.

In some configurations, the flexible portion comprises one of neoprene, rubber, a synthetic fiber mesh, and a natural fiber mesh.

In some configurations, the first member has a straight section. The straight section extends from the coupler to the second member. The straight section can be set at an angle with respect to the fishing pole in a top plane. The angle can be between 0° and 15°.

In some configurations, a straight section of the first member is parallel to the fishing pole in the hand grip portion.

In some configurations, the arm support is adjustable in one or both of along the longitudinal axis of the elongate pole and around the longitudinal axis of the fishing pole.

In some configurations, the arm support is radially offset a height from the hand grip portion, the height being between 0.75 and 1.5 inches.

In some configurations, the coupler further includes a first plate, a second plate, and a groove. The first and second plates couple around the elongate pole and the elongate pole is disposed within the groove. A support attachment couples with the second plate. The support attachment includes upper and lower sections with attachment grooves formed therebetween. The attachment grooves receive the arm support in a loose configuration and hold the arm support in a tightened configuration.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a schematic top view of a support connected to a fishing pole.

FIG. 2 is a schematic left side view of the support and fishing pole of FIG. 1.

FIG. 3 is a top view of a support connected to a fishing pole. The support has an armrest portion configured to contact a wrist or forearm of a user.

FIG. 4 is a perspective view of the fishing pole and support of FIG. 1.

FIG. 5 is a perspective view of another support connected to a fishing pole.

FIG. 6 is a perspective view of connection mechanism of the support of FIG. 5.

FIG. 7 is a perspective view of another support connected to a fishing pole.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “first,” “second,” “third,” and so on may be used to describe separate components. Such terminology may include the words specifically mentioned above, derivatives thereof, and words of similar import.

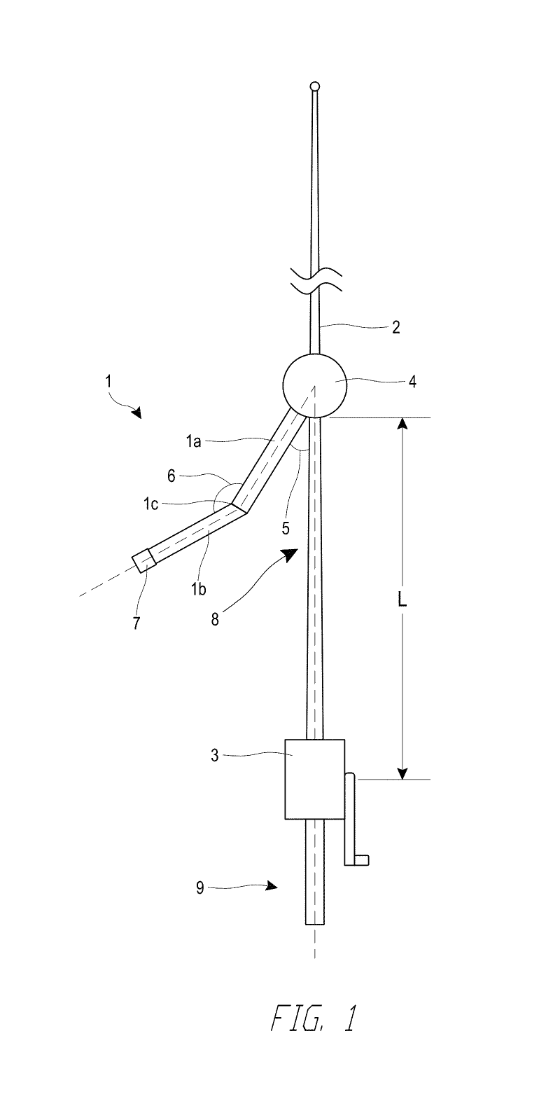

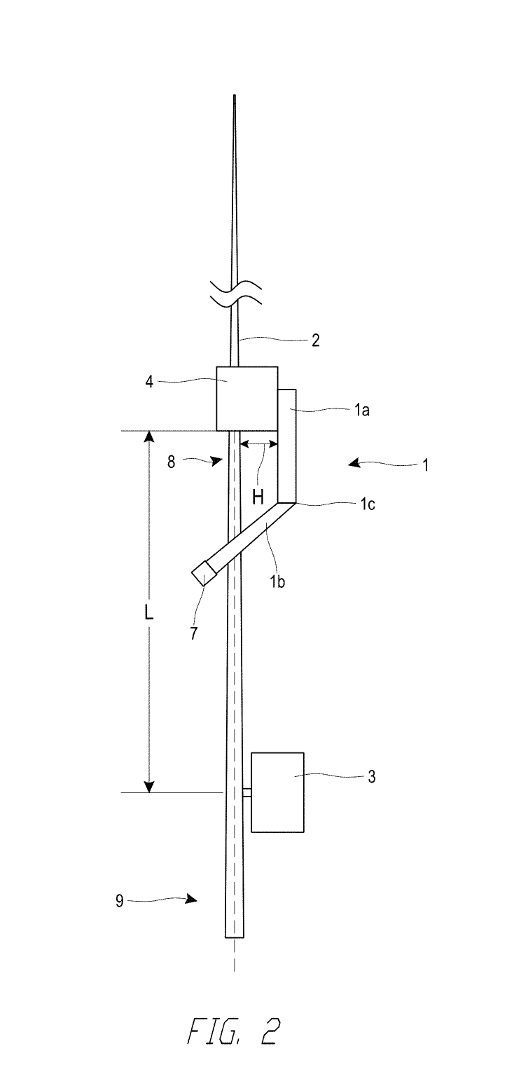

In a broad aspect, one or more embodiments are directed toward a leverage reduction support and torque reducer 1 for a fishing pole 2 (or other type of pole). FIGS. 1 and 2 illustrate a schematic embodiment of the support 1 attached to the fishing pole 2. The fishing pole 2 can be gripped and supported during use by a user's hands and arms. A grip hand can grip the fishing pole 2 while a reel hand is used to operate a reel 3. The support 1 can engage with the user's arm attached to the grip hand. In some implementations, the support 1 engages with an upper portion of the user's arm while the user's grip hand holds the fishing pole in a hand grip area 8. The hand grip area 8 can be located along the fishing pole 2 between the reel 3 and a coupler 4 of the support 1. When not being used to operate the reel 3, the reel hand can optionally grip the fishing pole 2 at the hand grip area 8, on the handle 9 or elsewhere on the pole 2.

The support 1 can include an armrest 7 (e.g., for engaging a wrist or forearm portion of an arm). The armrest 7 can be shaped to engage with a portion of the user's arm associated with the grip hand. The armrest 7 braces against the wrist or forearm of a user. In at least some embodiments, the armrest 7 is sized, shaped, positioned or otherwise configured to contact the upper surface of the user's wrist or forearm. That is, the engagement portion of the support is positioned above the user's wrist and forearm. The armrest 7 can include a soft brace. In some configurations, the soft brace can be in the form of a cupped handle, which can be pre-shaped or can be flexible such that it can assume a cupped shape when resting on and against the user's wrist or forearm. The soft brace can be made of a flexible and/or comfortable material. For example, the soft brace can be made from a rubber, or rubber-like material, neoprene, natural or synthetic cloth or woven mesh material, or other suitable material. The soft brace can be supported by a forked portion of the armrest 7.

The support 1 and armrest 7 can reduce user fatigue during use of the fishing pole 3. For example, the support 1 can distribute the load applied to the fishing pole (e.g., by a struggling fish on a fishing line) across the wrist and/or forearm of the user, rather than just the user's hands. By moving the load proximally along the length of the arm (e.g., towards the shoulder), the moment on the forearm (e.g., at the elbow) is reduced. Thus, shoulder and/or bicep fatigue while using the fishing pole 2 with the support 1 as compared with fishing using the pole 2 without the support 1.

Support 1 can include a first member 1a and a second member 1b. The first and second members 1a, 1b can be joined at an elbow 1c. The configuration of the first and second members 1a, 1b can increase user access to the hand grip area 8. The configuration of the first and second members 1a, 1b can also enable the armrest 7 to engage the user's arm in a location generally aligned with the wrist and/or forearm of the user's arm.

The support 1 can be attached with the fishing pole 2 by a coupler 4. The coupler 4 can be attached to a shaft or the rod of the fishing pole 2. The coupler 4 can be attached to the pole 2 using any appropriate mechanism such as a clamp around the outside of the fishing pole 2, a pin through the fishing pole 2 or other mechanical coupling. The coupler 4 can be attached forward (axially above) of the reel 3 and/or the hand grip area 8 along the pole 2. The support 1 can extend from the coupler 4 rearwardly toward the reel 3 and/or hand grip area 8. Optionally, the coupler 4 can be movable (e.g., by loosening the clamp) along and/or about the longitudinal axis of the fishing pole 2. The coupler 4 could also be configured to couple both the reel 3 and the support 1 to the fishing pole 2.

The support 1 can take any suitable shape. For example, the support 1 can include one or more members. In some implementations, the support 1 can include a single substantially straight member. In other implementations, the support 1 includes one or more straight and/or curved members. The multiple curved and straight members can be connected at one or more joints or angles. In certain implementations, the multiple curved and straight members can be adjustable relative to one another.

The first member 1a can include a straight section. The straight section can extend laterally away from the fishing pole 2 at an angle 5. The angle 5 can be between 0° and 90° (measured between an axis of the pole 2 and an axis of the support 1 in a top plane, as illustrated in FIG. 1). In some implementations, the angle 5 is between approximately 0° and 45°. In some implementations, the angle 5 is between approximately 0° and 15°. The first member 1a can also be angled upwards or downwards relative the pole 2. In some implementations, the angle 6 is be between 0° and 60° (measured between an axis of the pole 2 and an axis of the support 1 in a first plane). In some implementations, the angle can be between approximately 5° and 45°. The angle downwards can facilitate the armrest 7 engaging with the user's arm. In some implementations, the angle downwards is entirely within the second member 1b and/or the armrest 7 while the first member is generally parallel with the pole 2.

The coupler 4 can fixedly attached the support 1 at the angles 5 and/or the angle downwards. In some implementations, the coupler 4 can enable adjustment of the angles 5 and/or the angle downwards. The coupler 4 can also enable the length of the support 1 and/or hand grip portion 8 to be adjusted (e.g., by sliding the support 1 within the coupler 4). In this manner, the position of the support 1 with respect to the fishing pole 2 again can be adjusted based on the grip and stance of a user grasping the fishing pole 2.

The first member 1a can be positioned radially offset from the hand grip portion 8. The coupler 4 can provide the radial offset. The first member 1a can be disposed a height H above the hand grip portion 8 (as shown in FIG. 2) to facilitate the user gripping the user gripping area 8. In some implementations, the height H can be between 0.75″ and 1.5″.

The support 1 can be in the form of any item that is on the side of the reel 3 opposite of the reel handle and extends off (e.g., laterally) the pole 2 or reel 3 and that is configured to allow contact with a portion of the body of the user (e.g., the arm) to provide a torque reducer or a leverage enhancer function. In some configurations, the support 1 provides the user with additional lifting power compared to the pole 2, alone. For example, in some configurations, the support 1 enhances lifting power by 2 to 3 times the pole 2 on its own. The support 1 can be configured to provide stability to the fishing pole 2 while reeling and pulling in the fish. Moreover, the support 1 can enable a user greater access to the hand grip area 8 while utilizing the armrest 7. This enhanced access and flexibility can reduce fatigue and discomfort while using the pole 2.

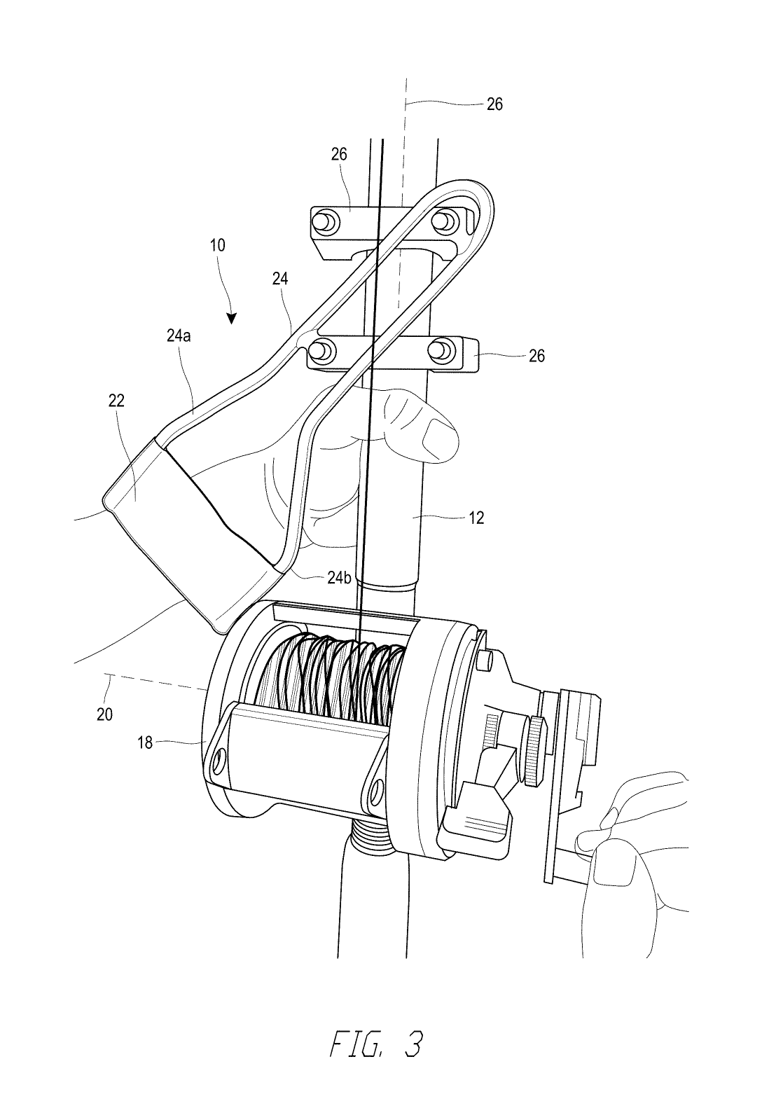

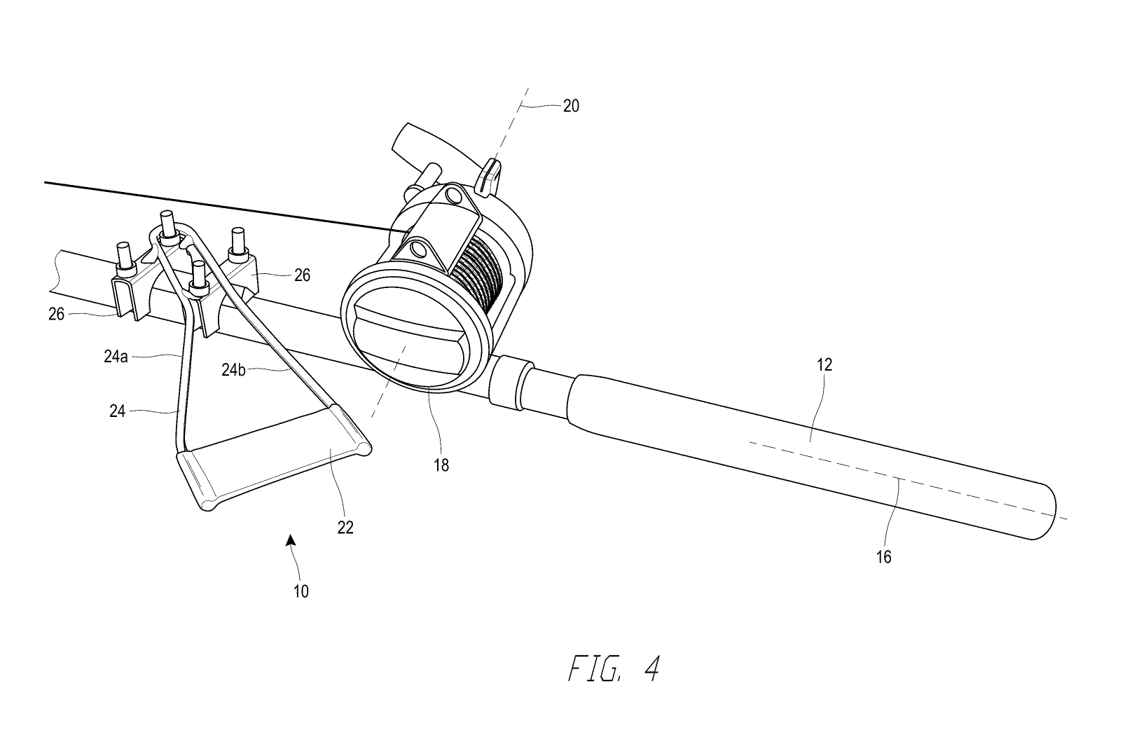

FIGS. 3 and 4 illustrate another support 10 coupled to a fishing pole 12. The support 10 is configured to assist a user 14 in resisting rotation of the fishing pole 12 about its longitudinal axis 16 or to assist the user 14 in lifting the fishing pole 12. In particular, the support 10 is configured to contact the arm of the user 14, such as the wrist or forearm, for example. Moreover, the support 10 can be configured to provide access to a hand grip portion 12a of the fishing pole 12. In at least some configurations, the support 10 is positioned above the arm of the user 14. The support 10 has a body that extends laterally from the longitudinal axis 16 of the fishing pole 12 when the fishing pole 12 is oriented with a reel 18 vertically above or below the fishing pole 12 and a rotational axis 20 of the reel 18 oriented horizontally. The illustrated reel 18 is positioned vertically above the fishing pole 12 (e.g., a conventional reel); however, the support 10 can also be utilized with a reel that is positioned vertically below the fishing pole 12 (e.g., a spinning reel).

The support 10 has an armrest portion 22 configured to contact the arm of the user 14 holding the fishing pole 12 at a spaced location from the fishing pole 12. The armrest portion 22 can be spaced in a lateral direction at least 2-3 inches from the closest edge of the fishing pole 12. Preferably, the armrest portion 22 is spaced from the longitudinal axis 16 of the fishing pole 12 a distance sufficient to counteract torque on the fishing pole 12 resulting from the user 14 reeling the reel 18 with his or her hand opposite the hand holding the fishing pole 12. The armrest portion 22 can also be spaced from the longitudinal axis 16 a distance sufficient to assist the user in lifting the fishing pole 12. In some configurations, the armrest portion 22 is spaced less than 12-18 inches from the longitudinal axis 16 of the fishing pole 12. The armrest portion 22 preferably is also at least even with a lower surface of the pole 12 or above the lower surface of the pole 12 when the reel 18 is vertically above or below the fishing pole 12.

In the illustrated arrangement, the support 10 comprises a frame 24 that supports the armrest portion 22. In some configurations, the armrest portion 22 comprises a flexible portion having an unsupported portion extending between spaced-apart portions of the frame 24. In the illustrated arrangement, the flexible portion is only supported at its ends by the spaced-apart portions of the frame 24. The illustrated frame 24 comprises a pair of spaced-apart arms 24a, 24b. The arms 24a, 24b and the frame 24 are cantilevered relative to the fishing pole 12. Such an arrangement spreads the load on the user's arm over a larger surface area than a rigid structure that does not conform to the user's arm for greater comfort over a longer period of time. It has been unexpectedly determined by the present inventor that such an arrangement substantially increases the amount of time a user can fish without significant discomfort relative to a less flexible or non-conforming armrest portion. Other suitable arrangements for spreading the load of the support 10 on the user's arm or for providing greater comfort can also be used.

In the illustrated arrangement, the armrest portion 22 is located beside or forward of the reel 18. In addition, the support 10 is coupled to the fishing pole 12 at a location forward of the reel 18 and forward of the hand grip portion 12a of the fishing pole 12 that is grasped by the user 14. However, in other arrangements, the support 10 can be coupled to the fishing pole 12 at a location rearward of the handgrip portion of the fishing pole 12 or rearward of the reel 18. In such an arrangement, the support 10 extend perpendicular to the longitudinal axis 16 of the fishing pole 12 or forward such that the armrest portion 22 can be located in the illustrated location or at another suitable location, as desired. In other arrangements, the support 10 can be mounted directly to the reel 18. The support 10 can be foldable into a stowed position, if desired, in any of the embodiments described herein.

In some configurations, the support 10 is adjustable relative to the fishing pole 12. For example, the support 10 can be adjusted along the longitudinal axis 16 or around the longitudinal axis 16 of the fishing pole 12. In the illustrated arrangement, the support 10 comprises one or more clamps 26 that connect the frame 24 to the pole 12. In one implementation, the clamps 26 each comprise a U-bolt connected with a brace. The clamps 26 can allow adjustment of the support 10 along the longitudinal axis 16 to allow adjustment of a fore-aft position of the armrest portion 22. The clamps 26 can also allow adjustment of the support 10 about the longitudinal axis 16 of the fishing pole 12 such that a rotational position of the armrest portion 22 can be adjusted. However, the armrest portion 22 is configured to be generally to the side of the reel 18, rather than in the same plane as the reel 18.

In some configurations, other suitable arrangements can used to mount the support 10 to the fishing pole 12 or to allow adjustment of the support 10 relative to the fishing pole 12 in the alternative or in addition to the clamps 26. For example, the frame 24 or armrest portion 22 can be mounted on a slide mechanism, telescoping mechanism, rotational mechanism or other suitable position adjustment mechanism to provide the desired range of adjustment. Preferably, one or more lock arrangements are provided to allow the adjusted position to be maintained. For example, clamp or cam lock arrangements can be used.

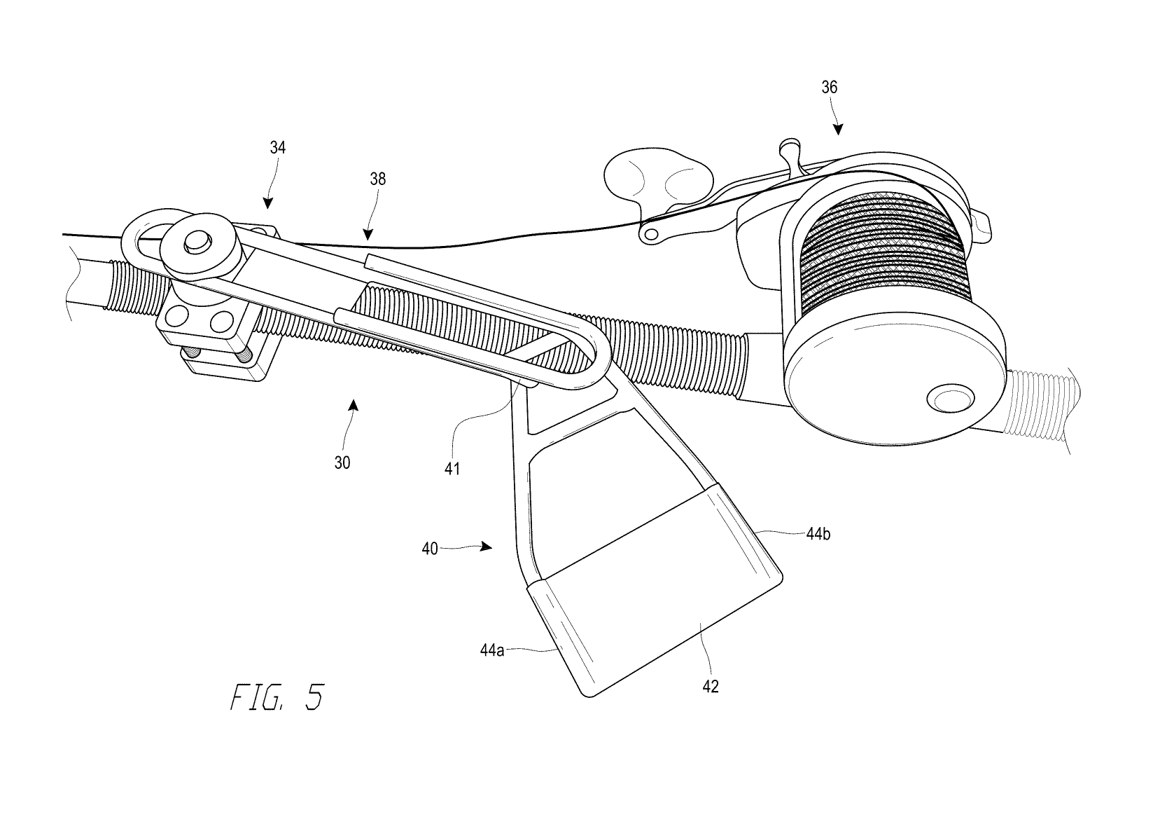

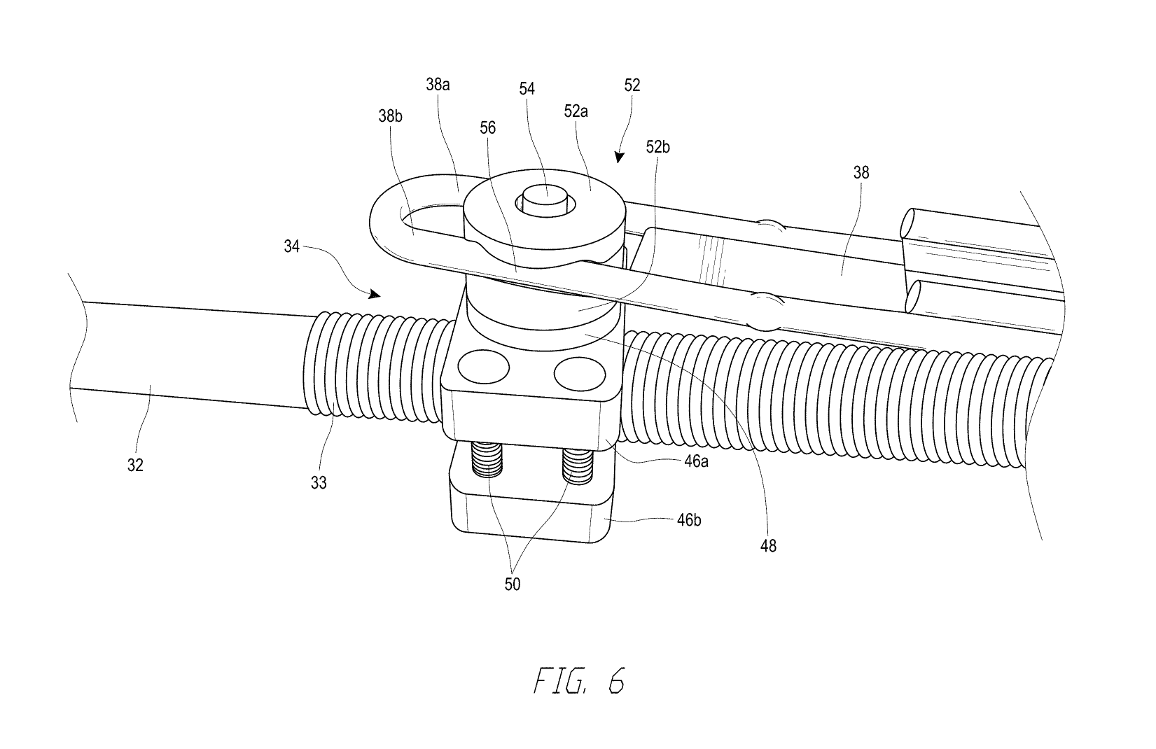

FIGS. 5 and 6 illustrates another support 30. The support 30 can be attached to a fishing pole 32. The fishing pole 32 can include a reel 36. The reel 36 can be any style of reel (e.g., attached above or below the fishing pole 32). The support 30 can function similarly to the supports 1 and 10 described above (e.g., provide leverage enhancement and/or torque resistance along the pole 32). The support 30 can include a first member 38 and a second member 40. The first and second members 38, 40 can be attached at a junction 41. The junction 41 can form an angle such that the first member 38 is set at an angle with respect to the second member 40.

The second member 40 can include an armrest 42. The armrest 42 can include a pad or other engagement feature for resting against the user (e.g., against the user's wrist, forearm, or other bodily surface). The armrest 42 can be fixed between first and second sides 44a, 44b of the second member 40. In one implementation, the armrest 42 comprises a span of a flexible material (e.g., neoprene, rubber, a synthetic fiber mesh, and a natural fiber mesh) with two receiving slots fitted over the first and second sides 44a, 44b.

The first member 38 can be coupled with fishing pole 32 by a coupler 34. The coupler 34 can attach above a handgrip portion 32a of the pole 32. The coupler 34 can provide a secure and fixed connection between the fishing pole 32 and the support 30. The coupler 34 can also allow for adjustment of the position of the support 30 with respect to the fishing pole 32. For example, the coupler 34 can also allow for the support 30 to be attached at various places and/or various orientations along the length of the fishing pole 32 (e.g., up or down the pole relative to the reel 36). The location and position of the coupler 34 can be adjusted to suit the needs of a user. For example, the coupler 34 can be used to ensure that the support pad 42 rests in the desired location of the user's arm such as the wrist or forearm and is generally aligned therewith.

The coupler 34 also enables attachment of the support 30 with a variety of diameters and types of the fishing poles. Optionally, the coupler 34 can be installed over a grip component 33 of the fishing pole 32. For example, the grip component 33 can be a rubber sleeve or other coating that provides additional gripping surface for attaching and/or holding the fishing pole 32.

The coupler 34 can include an upper coupler component 46a and a lower coupler component 46b. The upper and lower coupler components 46a, 46b can include a groove for receiving a portion of the fishing pole 32. The groove can be in either or both of the upper and lower coupler components 46a, 46b. The upper and lower coupler components 46a, 46b, can attach on opposite sides of the fishing pole 32.

The coupler 34 can include one or more fasteners 50. The fasteners 50 can be mechanical fasteners such as screws, nuts and bolts or other mechanical couplers for coupling together the upper and lower coupler components 46a, 46b. The lower coupler component 46b can include one or more threaded holes aligned with corresponding holes in the upper coupler component 46a. The plurality of couplers 50 can be inserted through the holes of the upper couple component 46 and attached within the threaded holes of the lower coupler component 46b. In other implementations, the location of the threaded holes and holes can be reversed.

The coupler 34 can also include a support attachment 52. The support attachment 52 can be coupled with either of the upper or lower coupler components 46a, 46b. For example, the upper coupler component 46a can include an attachment boss 48. The support attachment 52 can include a central pin 54 for attachment with the upper coupler component 46a (e.g., at the attachment boss 48). The support attachment 52 can include a central hole through which the pin 54 can be inserted and attached within a corresponding threaded hole within the attachment boss 48. The attachment pin 54 can be loosened to allow for the support attachment 52 to be rotated with respect to the upper coupler component 46a (e.g., about the pin 54). The coupler 34 can thereby enable for adjustment of the angle of the support 30 with respect to the fishing pole 32. The coupler 34 can also attach at various orientations around the outer circumference of the pole 32. The attachment pin 54 can be tightened to allow for the support attachment 52 to be held firmly with respect to the upper coupler component 46a.

The first member 38 of the support 30 can include first and second sides 38a, 38b. The first and second sides 38a, 38b can be attached with the coupler 34 by the support attachment 52. The support attachment 52 can include one or more attachment grooves 56. In some implementations, the support attachment can include upper and lower sections 52a, 52b, with the grooves 56 formed therebetween. The attachment grooves 56 can receive the first and second sides 38a, 38b. The first and second sides 38a, 38b can be inserted into the attachment grooves 56 with the support attachment 52 in a loose configuration (e.g., the pin 54 is loose). The first and second sides 38a, 38b can be held firmly within the grooves 56 in a tightened configuration (e.g., the pin 54 is tightened). A length of the support 30 (e.g., the extension of the support 30 away from the pole 32) can be adjusted by sliding the first and second sides 38a, 38b within the grooves 56.

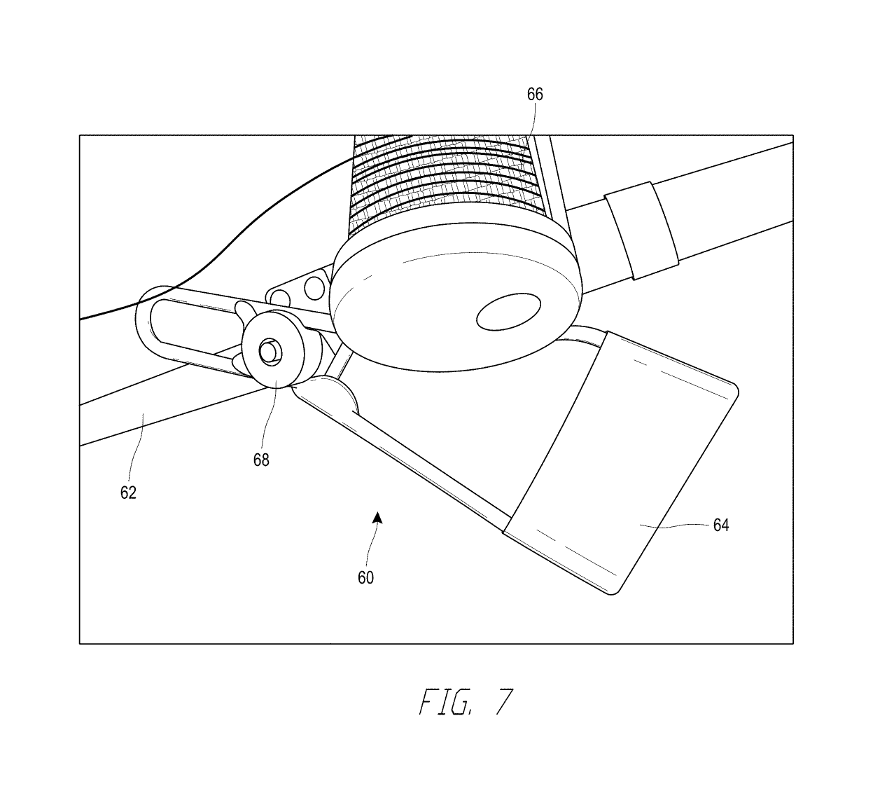

FIG. 7 illustrates another embodiment of a support 60. Support 60 can be attached with a fishing pole 62. The fishing pole 62 can be similar to the fishing poles 2, 12 and 32 described above. A coupler 68 can attach the support 60 with the pole 62. Support 60 is similar to support 30 but it does not include the joint 41 forming the first and second portion 38, 40. The support 60 can be attached with the pole 63 such that a portion of the support 60 is installed directly underneath a reel 66. This compact assembly of the support 60 and the coupler 68 illustrates that a range of positions of the support 60 with respect to the fishing pole 62 and the reel 66 is contemplated by the enclosed description. Furthermore, the support 60 is curved over its length, or comprises a curve, to enable an armrest 64 to rest comfortably on the wrist and/or forearm of a user holding the fishing pole 62.

### Conclusion

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. A fishing pole, comprising:
an elongate pole, the elongate pole defining a longitudinal axis;
a handle portion providing a first hand grip portion of the elongate pole, the handle portion coupled with a first end of the elongate pole;
a reel for controlling a fishing line, the reel coupled with the elongate pole at a location axially forward of the first end along the longitudinal axis, the reel radially offset above or below the longitudinal axis;
an arm support for engaging with an upper portion of a user's arm, the armrest coupled with the elongate pole at a location axially forward of the reel along the longitudinal axis; and
a coupler attaching the arm support with the elongate pole such that the arm support can maintain a position with respect to the elongate pole, the arm support extending along and radially offset above a second hand grip portion of the elongate pole, the second hand grip portion located between the coupler and the reel;
wherein the arm support is configured to contact an upper portion of the arm of a user at a spaced location from the fishing pole, the arm attached to a hand that grips the fishing pole in the second hand grip portion.

2. The fishing pole of claim 1, the arm support further comprising:
a first member, the first member extending along the second hand grip portion from the coupler towards the reel and radially offset from the second hand grip portion;
a second member coupled with the first member, the second member extending generally radially with respect to the longitudinal axis, the second member including an armrest portion;
wherein the armrest portion contacts a forearm or wrist portion of the arm and is generally aligned therewith.

3. The fishing pole of claim 2, wherein the armrest portion includes a frame and a flexible portion extending between spaced-apart portions of the frame, the flexible portion supported at its ends by the spaced-apart portions of the frame.

4. The fishing pole of claim 3, wherein the flexible portion comprises one of neoprene, rubber, a synthetic fiber mesh, and a natural fiber mesh.

5. The fishing pole of claim 2, wherein the first member comprises a straight section, the straight section extending from the coupler to the second member, the straight section set at an angle with respect to the elongate pole in a top plane, the angle being between 0° and 15°.

6. The fishing pole of claim 2, wherein a straight section of the first member is parallel to the elongate pole in the second hand grip portion.

7. The fishing pole of claim 1, wherein the arm support is adjustable in one or both of along the longitudinal axis of the elongate pole and around the longitudinal axis of the fishing pole.

8. The fishing pole of claim 1, wherein the arm support is radially offset a height from the second hand grip portion, the height being between 0.75 and 1.5 inches.

9. The fishing pole of claim 1, the coupler further comprising:
a first plate, a second plate, and a groove, the first and second plates coupled around the elongate pole and the elongate pole disposed within the groove;
a support attachment coupled with the second plate, the support attachment including upper and lower sections with attachment grooves formed therebetween, the attachment grooves configured to receive the arm support in a loose configuration and to rigidly hold the arm support in a tightened configuration.

10. An arm support for attaching to a fishing pole and improving access to a hand grip portion of the fishing pole, comprising:
a first member, the first member configured to be coupled with the fishing pole at a location axially forward a reel of the fishing pole;
a second member coupled with the first member, the second member including an armrest, the armrest configured to contact an upper portion of a forearm or wrist portion of a user's arm, the arm attached to a hand that grips the fishing pole in the hand grip portion;
a coupler, the coupler configured to attach the first member with the fishing pole such that the arm support can maintain a position with respect to the fishing pole;
wherein the first member is configured to extend along the hand grip portion from the coupler towards the reel, the first member radially offset above the second hand grip portion.

11. The arm support of claim 10, wherein the armrest includes a frame and a flexible portion extending between spaced-apart portions of the frame, the flexible portion supported at its ends by the spaced-apart portions of the frame.

12. The arm support of claim 11, wherein the flexible portion comprises one of neoprene, rubber, a synthetic fiber mesh, and a natural fiber mesh.

13. The arm support of claim 10, wherein the first member comprises a straight section, the straight section extending from the coupler to the second member, the straight section configured to be set at an angle with respect to the fishing pole in a top plane, the angle being between 0° and 15°.

14. The arm support of claim 10, wherein a straight section of the first member is parallel to the fishing pole in the hand grip portion.

15. The arm support of claim 10, wherein the arm support is adjustable in one or both of along the longitudinal axis of the elongate pole and around the longitudinal axis of the fishing pole.

16. The arm support of claim 10, wherein the arm support is radially offset a height from the hand grip portion, the height being between 0.75 and 1.5 inches.

17. The arm support of claim 10, the coupler further comprising:
a first plate, a second plate, and a groove, the first and second plates coupled around the elongate pole and the elongate pole disposed within the groove;
a support attachment coupled with the second plate, the support attachment including upper and lower sections with attachment grooves formed therebetween, the attachment grooves configured to receive the arm support in a loose configuration and to rigidly hold the arm support in a tightened configuration.

18. A fishing pole assembly comprising:
a support that extends laterally from a longitudinal axis of a fishing pole, the support comprising an armrest that rests in contact with a portion of a user's arm when holding the fishing pole assembly;
a coupler that attaches the support to the fishing pole, the coupler configured to allow for adjustment of a position of the support with respect to the fishing pole.

19. The fishing pole assembly of claim 18, the armrest further comprising:
a frame having two space-apart portions;
a flexible portion extending between the spaced-apart portions, the flexible portion supported at its ends by the spaced-apart portions;
wherein the flexible portion comprises one of neoprene, rubber, a synthetic fiber mesh, and a natural fiber mesh.

20. The fishing pole assembly of claim 18, the coupler further comprising:
an upper coupler component and a lower coupler component, the upper and lower coupler components configured to be assembled around the fishing pole;
a support attachment for attaching one end of the support with the coupler;
a groove, the fishing pole received within the groove;
wherein in a loosened state, the attachment allows adjustment of the position of the support and in a tightened state, the attachment fixedly secures the position of the support; and
wherein the coupler includes an attachment comprising a pin, the support rotatable about the pin in the loosened state.
